(19) United States
(12) Patent Application Publication
(10) Pub. No.: US 2025/0206608 A1
(43) Pub. Date: Jun. 26, 2025

(54) SEPARATIONS FOR METHANE PYROLYSIS

(71) Applicant: EXXONMOBIL TECHNOLOGY AND ENGINEERING COMPANY, Spring, TX (US)

(72) Inventors: Peter I. RAVIKOVITCH, Princeton, NJ (US); Bennett D. MARSHALL, Bethlehem, PA (US); Sarah E. FEICHT, Branchburg, NJ (US); Yu WANG, Lebanon, NJ (US)

(21) Appl. No.: 18/985,621

(22) Filed: Dec. 18, 2024

Related U.S. Application Data
(60) Provisional application No. 63/613,340, filed on Dec. 21, 2023.

(51) Int. Cl. C01B 3/56

(52) U.S. Cl. CPC C01B 3/56; C01B 2203/1241; C01B 2210/0017; C01B 2210/0018; C01B 2210/0046; C01B 2210/0051

(57) ABSTRACT

Systems and methods are provided for separation of a high purity hydrogen stream from methane pyrolysis effluents when using a plurality of adsorbent beds. The methods can allow for increased recovery of hydrogen from the methane pyrolysis effluent while maintaining a target purity for the hydrogen product stream of 98.0 vol % or more.

### CROSS-REFERENCE TO RELATED APPLICATIONS

This Non-Provisional Patent application claims priority to U.S. Provisional Patent Application No. 63/613,340, filed Dec. 21, 2023, and titled “Separations For Methane Pyrolysis”, the entire contents of which is incorporated herein by reference.

### FIELD OF THE INVENTION

Systems and methods are provided for separating products generated by methane pyrolysis.

### BACKGROUND OF THE INVENTION

Methane pyrolysis (or more generally hydrocarbon pyrolysis) is a process that can convert natural gas to hydrogen and solid carbon products. One advantage of this method for hydrogen generation is that the carbon primarily forms a solid phase, and therefore the large majority of the carbon does not need to be separated from the product stream containing the hydrogen. The resulting hydrogen product stream is further purified to achieve a desired product purity, typically 95-99.9%.

Although the majority of the carbon is converted into solid carbon in methane pyrolysis, one of the current limitations for methane pyrolysis as a source of hydrogen generation is the ability to separate the hydrogen generated by the pyrolysis process into a high purity stream. This is due in part to the fact that typical natural gas streams (and/or other methane-containing hydrocarbon streams) typically also contain N₂, O₂, and/or oxygen-containing compounds such as water. Some removal of these nitrogen- and oxygen-containing substances can be performed prior to performing pyrolysis. But typical hydrocarbon streams used for a pyrolysis process still contain some nitrogen and oxygen (and/or oxygen-containing compounds). The oxygen and/or oxygen-containing compounds can result in the presence of water, CO, and CO₂ in the hydrogen-containing product stream. Thus, to achieve target purities of higher than 95% for the hydrogen-containing product stream, additional separations need to be performed.

In addition to nitrogen and carbon oxides, the hydrogen-containing product stream typically also contains unreacted methane that needs to be recycled back to the pyrolysis reactor. In the recycle, contaminants that enter with the feed (and that are separated out from the hydrogen-containing product stream) can build up. A purge stream is typically incorporated to remove contaminants such as nitrogen and CO₂.

Another challenge of using methane pyrolysis for hydrogen production is the relatively low pressure of the resulting hydrogen product stream. Compared to other hydrogen production processes such as steam methane reforming (SMR) and autothermal reforming (ATR), methane pyrolysis operates at low pressures, typically ranging from 1-10 bar. This low pressure limits the pressure ratio available for a conventional pressure swing adsorption (PSA) separation process. It would be desirable to have improved methods for using swing adsorption processes for producing high purity hydrogen product streams from methane pyrolysis effluents, while still incorporating a high percentage of the hydrogen from the methane pyrolysis effluent into the hydrogen product stream.

U.S. Patent 2010/0000408 describes a hydrogen gas separation method and a separation apparatus. The method includes exposing a gas for separation sequentially to activated carbon followed by a molecular sieve corresponding to Ca-A-type molecular sieve, Ca—Z-type molecular sieve, or Li—X-type molecular sieve.

U.S. Pat. No. 7,179,324 describes a continuous feed three-bed pressure swing adsorption system. The process cycle for the system includes purge steps.

U.S. Patent Application Publication 2018/0001301 describes examples of structured adsorbent beds.

U.S. Patent Application Publication 2021/0331918 describes performing methane pyrolysis using stacked fluidized beds.

### SUMMARY OF THE INVENTION

In an aspect, a method for separating hydrogen from methane pyrolysis products using a plurality of adsorbent beds is provided. The method includes performing pyrolysis on a feed containing C₁-C₄ hydrocarbons to form a pyrolysis effluent. The pyrolysis effluent can contain, on a dry basis, 60 vol % or more of H₂ and 1.0 vol % or more CH₄. Additionally, the method includes separating at least a portion of the pyrolysis effluent to form a hydrogen-containing effluent, a recycle stream, and a purge stream. The hydrogen-containing stream can contain 98.0 vol % or more H₂. Optionally, the hydrogen-containing stream can contain 70 vol % or more of the H₂ contained in the feed and/or the recycle stream can contain 80 vol % or more of the CH₄ contained in the feed.

Optionally, the feed can further include N₂. In such an optional aspect, the pyrolysis effluent can contain 7.0 vol % or less of N₂ and/or the hydrogen-containing stream can contain 1.0 vol % or more N₂.

Optionally, the separating at least a portion of the pyrolysis effluent can correspond to using a separation process that comprises a pressure of 50 kPa-a or less to form the hydrogen-containing effluent, the recycle stream, and the purge stream.

Optionally, the separating at least a portion of the pyrolysis effluent can correspond to exposing the at least a portion of the pyrolysis effluent to a parallel channel contactor to form the hydrogen-containing effluent, the recycle stream, and the purge stream. An example of a parallel channel contactor can be a monolith. Optionally, the parallel channel contactor can have a void fraction of 36% or less.

In another aspect, a method for separating hydrogen from methane pyrolysis products using a plurality of adsorbent beds is provided. The method includes performing pyrolysis on a feed containing C₁-C₄ hydrocarbons to form a pyrolysis effluent containing, on a dry basis, 60 vol % or more of H₂ and 1.0 vol % or more CH₄. Additionally, the method includes separating at least a portion of the pyrolysis effluent using a separation process including exposing the at least a portion of the pyrolysis effluent to a structured adsorbent contactor to form a hydrogen-containing effluent, a recycle stream, and a purge stream, the hydrogen-containing stream containing 98.0 vol % or more H₂. Optionally, the hydrogen-containing stream can contain 70 vol % or more of the H₂ contained in the feed and/or the recycle stream can contain 80 vol % or more of the CH₄ contained in the feed.

### BRIEF DESCRIPTION OF THE DRAWINGS

FIG. 1 shows an example of a configuration for a plurality of sorbent beds.

FIG. 2 shows an example of a sorbent bed configuration.

FIG. 3 shows an example of another configuration for a plurality of sorbent beds.

FIG. 4 shows an example of another sorbent bed configuration.

FIG. 5 shows an example of another sorbent bed configuration.

FIG. 6 shows the relationship between membrane size and compressor duty for separating CO₂ from a flue gas at a representative set of conditions.

FIG. 7 shows an example of a configuration for integrating a pyrolysis process with a PSA or VPSA separation stage.

FIG. 8 shows pressure within a sorbent bed during modeled operation of a VPSA separation process.

FIG. 9 shows adsorbed component profiles within the sorbent bed of FIG. 8.

FIG. 10 shows pressure within a sorbent bed during modeled operation of a PSA separation process.

### DETAILED DESCRIPTION OF THE EMBODIMENTS

All numerical values within the detailed description and the claims herein are modified by “about” or “approximately” the indicated value, and take into account experimental error and variations that would be expected by a person having ordinary skill in the art.

### Overview

In various aspects, systems and methods are provided for separation of a high purity hydrogen stream from methane pyrolysis effluents. The methods can allow for increased recovery of hydrogen from the methane pyrolysis effluent while maintaining a target purity for the hydrogen product stream of 98.0 vol % or more, or 99.0 vol % or more, such as up to being substantially composed only of hydrogen (99.9 vol % or more).

Conventionally, the requirements for forming a high purity hydrogen-containing product stream in combination with the low starting pressure of the pyrolysis effluent has resulted in separation processes that can achieve a target purity, but at the cost of limiting the amount of hydrogen that is recovered from the pyrolysis effluent. The hydrogen not recovered is lost as purge gas and/or recycled back to the process along with the methane, thus increasing required reactor volumes.

In some aspects, systems and methods are provided for improving recovery of hydrogen from a pyrolysis effluent while maintaining a target purity for the hydrogen-containing product (such as a product stream) by eliminating the need for using a portion of the hydrogen-containing product as a purge stream for the sorbent bed during the process. In such aspects, use of a purge stream can be avoided by using a vacuum pressure swing adsorption (VPSA) cycle with an appropriate selection of steps. For example, in some aspects, a cycle can be used where the sorbent is evacuated at a pressure of less than 90 kPa-a for a time period that is at least twice as long as the time the sorbent is exposed to a flow of pyrolysis effluent. An adsorbent can be used that improves or maximizes methane recovery while also increasing the portion of nitrogen that is removed with the hydrogen-containing product. The resulting hydrogen-containing product can be formed with an H₂ content of 98.0 vol % or more, or 99.0 vol % or more, such as up to being substantially entirely composed of hydrogen (99.9 vol % or more).

Additionally or alternately, in some aspects, systems and methods are provided for improving productivity and recovery of hydrogen from a pyrolysis effluent while maintaining target purity for the hydrogen-containing stream by performing pressure swing adsorption using adsorption vessels that contain a structured adsorbent. By using a structured adsorbent with an appropriate sorbent material, contact between a pyrolysis effluent and the sorbent can be improved, resulting in improved recovery of hydrogen while maintaining high purity in the product stream. A structured adsorbent can also improve the productivity of the process. The structured adsorbent can correspond to substantially parallel channel monolith configuration, with sorbent material coated on interior surfaces of the parallel channels.

Further additionally or alternately, pressure swing adsorption (PSA) processes (performed without reducing the pressure below 90 kPa-a) are provided that use an improved separation cycle to increase hydrogen recovery while maintaining a target purity. Optionally, a structured adsorbent can be used to further improve recovery in such PSA processes. The resulting hydrogen-containing product can be formed with an H₂ content of 80 vol % or more, or 90 vol % or more, or 95 vol % or more, or 98.0 vol % or more, or 99.0 vol % or more, such as up to being substantially entirely composed of hydrogen (99.9 vol % or more).

Additionally or alternately, the hydrogen-containing product can also contain an increased or maximized amount of the hydrogen that is present in the pyrolysis effluent prior to separation to form the hydrogen-containing product. In some aspects, the hydrogen-containing product (such as a product stream) can contain 70 vol % or more of the H₂ contained in the pyrolysis effluent prior to separation, or 80 vol % or more, such as up to 98 vol % or possibly still more.

In some optional aspects, if the pyrolysis effluent contains N₂, the resulting hydrogen-containing product can contain 0.5 vol % or more of N₂, or 1.0 vol % or more, such as up to 2.5 vol % or possibly still more. Additionally or alternately, the N₂ in the hydrogen-containing product can contain 5.0 vol % or more of the N₂ contained in the pyrolysis effluent, or 10 vol % or more, or 15 vol % or more, such as up to 25 vol % or possibly still more.

The pyrolysis effluent can also typically contain unreacted methane. Separation of the pyrolysis effluent can also result in formation of a recycle stream that includes at least a portion of the unreacted methane. This can allow the unreacted methane to be returned to the pyrolysis process. In some aspects, a recycle stream can be formed that contains 70 vol % or more of the methane present in the pyrolysis effluent, or 80 vol % or more, or 85 vol % or more, or 90 vol % or more, such as up to 99 vol % or possibly still higher.

Typically, the pyrolysis effluent can also contain carbon oxides (CO or CO₂). In some aspects, the pyrolysis effluent can contain 5.0 vol % or less of carbon oxides, or 3.0 vol % or less, such as down to 0.1 vol % or possibly still lower. In such aspects, the recycle stream can contain 90 vol % or less of the carbon oxides contained in the pyrolysis effluent, or 85 vol % or less, or 80 vol % or less, such as down to 65 vol % or possibly still lower. Such a recycle stream can also contain 90 vol % or less of the N₂ contained in the pyrolysis effluent, or 85 vol % or less, or 80 vol % or less, or 75 vol % or less, such as down to 65 vol % or possibly still lower.

In some aspects, the sorbent materials used for the VPSA and/or PSA processes can correspond to conventional materials for separation of H₂ from CO₂ and CH₄. Examples of such materials include zeotype materials (such as zeolitic materials) and activated carbon.

In some aspects, at least a first portion of a purge stream and/or an evacuation stream can be used for recycle to the pyrolysis process, while a second portion of the purge stream and/or evacuation stream can be purged from the separation system so as to avoid buildup of contaminants such as N₂. Optionally, such a purged portion of the purge stream and/or evacuation stream can be used as a fuel for other processes.

### Definitions

In this discussion, a zeolite is defined to refer to a crystalline material having a porous framework structure built from tetrahedra atoms connected by bridging oxygen atoms. Examples of known zeolite frameworks are given in the “Atlas of Zeolite Frameworks” published on behalf of the Structure Commission of the International Zeolite Association”, 6^{th} revised edition, Ch. Baerlocher, L. B. McCusker, D. H. Olson, eds., Elsevier, New York (2007) and the corresponding web site, http://www.iza-structure.org/databases/. Under this definition, a zeolite can refer to aluminosilicates (i.e., zeolites) having a zeolite framework structure as well as crystalline structures containing oxides of heteroatoms different from silicon and aluminum. Such heteroatoms can include any heteroatom generally known to be suitable for inclusion in a zeotype framework, such as gallium, boron, germanium, phosphorus, zinc, and/or other transition metals that can substitute for silicon and/or aluminum in a zeotype framework. It is noted that under this definition, a zeotype can include materials such as silicoaluminophosphate (SAPO) materials or aluminophosphate (AlPO) materials.

In this discussion, a siliceous zeolite is defined as a crystalline material including both silicon and aluminum as atoms in the framework structure, wherein the silicon to aluminum ratio for the framework structure is 70 or more, or optionally 100 or more, such as up to 600 or possibly still higher. More generally, a zeolite can have a silicon to aluminum ratio of 3 or more, or 10 or more, or 30 or more.

### Separation of Pyrolysis Effluent—Vacuum Pressure Swing Adsorption Cycle

In various aspects, a vacuum pressure swing adsorption cycle can be used to provide improved recovery of hydrogen while maintaining a target purity of 98.0 vol % or more, or 99.0 vol % or more, such as up to 99.9 vol % or possibly still higher. Using simulations, it has been discovered that a purge step can be avoided by using a cycle that includes a sufficient length of bed evacuation at pressures below 90 kPa-a.

An example of a twelve step process cycle will be illustrated using a configuration involving twelve sorbent beds, with the sorbent beds being roughly comparable in size and the vessels containing the sorbent beds being roughly comparable in volume. However, it is understood that any convenient number of sorbent beds can be used that is consistent with performing the cycle. In the illustrative example, each step of the cycle is the same length, to allow for synchronization between beds at certain points in the cycle. It is understood that with a different number of sorbent beds, other process synchronization cycles could be developed.

The vacuum pressure swing adsorption cycle described herein can provide a variety of advantages, including increasing or maximizing hydrogen recovery in the hydrogen-containing product; increasing or maximizing methane recovery for recycle back to the pyrolysis process; and reducing or minimizing the moles of inert compounds (such as N₂) that are recycled to the pyrolysis process.

In this example, both Step 1 and Step 2 correspond to adsorption steps, where the sorbent is exposed to a flow of the pyrolysis effluent. This produces a sorbent with an increased loading of methane and carbon oxides, and an adsorption effluent that has an H₂ (hydrogen) content of 98.0 vol % or more, or 99.0 vol % or more. This step is performed at a pressure between 500 kPa-a and 2000 kPa-a. It is noted that a typical pressure for a pyrolysis effluent produced by a pyrolysis process is between roughly 100 kPa-a and 1000 kPa-a. In some aspects, no compression may be needed for the pyrolysis effluent. In other aspects, compression can be performed to increase the pressure of the pyrolysis effluent to a target pressure for the start of the separation process.

In the adsorption steps corresponding to Step 1 and Step 2, various temperatures can be used. Temperatures near room temperature can be convenient for processing, but lower temperatures can potentially provide a higher purity adsorption effluent. In some aspects, the temperature can be between −50° C. and 40° C. The velocity of gas in the sorption environment during the adsorption steps can vary depending on the configuration of the sorbent environment. In some aspects, the gas velocity during the sorption steps can be roughly between 0.01 m/s to 10 m/s, or 0.01 m/s to 5.0 m/s, or 0.01 m/s to 1.0 m/s. The resulting adsorption effluent having an H₂ content of 98.0 vol % or more is produced at a pressure similar to the pressure during the adsorption step.

It is noted that the hydrogen-containing product formed during Step 1 and Step 2 can include a reduced or minimized amount of the methane present in the pyrolysis effluent. In various aspects, the hydrogen-containing product can contain 5.0 mol % or less of the methane that was contained in the pyrolysis effluent, or 4.0 mol % or less, such as down to 1.0 mol % or possibly still less. Additionally or alternately, the hydrogen-containing product can contain a reduced or minimized amount of carbon oxides (CO and CO₂). In various aspects, the hydrogen-containing product can contain 0.2 mol % or less of the carbon oxides that were contained in the pyrolysis effluent, or 0.1 mol % or less, such as down to having substantially no carbon oxide content.

Step 3 corresponds to a first pressure equalization step, where the first bed is placed in fluid communication with a second bed that is at a different (lower pressure) step in the process cycle. The pressure from the first bed is allowed to equalize with the pressure in the second bed. In some aspects, this pressure equalization is performed by connecting only one end of the first bed with one end of the second bed. Pressurizing using a flow only from one end of the pressurized bed can assist with improving the purity of the H₂ stream generated by the separation process. This is in contrast to a pressure equalization process where pressure equalization is performed using gas flows from both ends of the pressurized bed. At the start of the pressure equalization step, the first bed will be at a pressure between 500 kPa-a and 1500 kPa-a, while the second bed will be at a pressure between 180 kPa-a and 500 kPa-a. After equalization, the pressure in the both beds will roughly correspond to an average of the pressures prior to equalization. In some aspects, the pressure in the first bed and second bed after equalization can be 350 kPa-a to 1000 kPa-a. Additionally or alternately, in some aspects, the final pressure in both beds after equalization can correspond to a pressure that is 60% to 80% of the pressure in the first bed prior to the start of the equalization step. In other words, a ratio of the pressure in the first bed at the end of the first equalization step to a pressure in the first bed prior to the start of the first equalization step is between 0.60 and 0.80. Because this is a pressure equalization step, the output flow from the first bed serves as the input flow to the second bed.

Step 4 corresponds to a second pressure equalization step, where the first bed is placed in fluid communication with a third bed that is at a different (lower pressure) step in the process cycle than either the first bed or the second bed. The pressure from the first bed is allowed to equalize with the pressure in the third bed. In some aspects, at the start of the pressure equalization step, the first bed will be at a pressure between 350 kPa-a and 1000 kPa-a (based on the first equalization step). Additionally or alternately, in some aspects, the pressure in the first bed can be 60% to 80% of the pressure in the first bed during the first and second adsorption steps. In various aspects, prior to the second pressure equalization, the pressure in the second bed can be between 5.0 kPa-a and 60 kPa-a. After equalization, the pressure in both beds will roughly correspond to an average of the pressures prior to equalization. In some aspects, the pressure in the first bed and third bed after equalization can be 180 kPa-a to 500 kPa-a. In some aspects, the final pressure in both beds after equalization can correspond to a pressure that is 50% to 60% of the pressure in the first bed prior to the start of the second equalization step. In other words, a ratio of the pressure in the first bed at the end of the second equalization step to a pressure in the first bed prior to the start of the second equalization step is between 0.50 and 0.60. Because this is a pressure equalization step, the output flow from the first bed serves as the input flow to the third bed. It is noted that the pressure in the first bed at the end of the second pressure equalization step should be high enough so that desorption of methane and/or CO₂ from the sorbent bed is reduced or minimized. This reduces, minimizes, and/or prevents transfer from the first bed, which is about to be regenerated, to another bed that is about to start an adsorption step for production of hydrogen-containing product.

Step 5 corresponds to a blowdown step, to reduce the pressure in the first bed to roughly ambient pressure (roughly 100 kPa-a). Because pressure is being released, no input flow is needed for the blowdown step. The blowdown step generates a blowdown exhaust. In some aspects, the blowdown exhaust can correspond to a counter-current flow, relative to the direction of flow in the first bed in Steps 1 to 4. Due to the reduction in pressure, the methane and carbon oxides adsorbed in the sorbent bed are at least partially desorbed during the blowdown. Thus, in addition to containing H₂ the blowdown exhaust corresponds to a stream with an increased content of methane and CO₂ relative to the composition of the pyrolysis effluent. In various aspects, blowdown exhaust can contain 20 vol % to 50 vol % of methane, relative to the volume of the blowdown exhaust. This blowdown exhaust can be compressed and recycled back to the pyrolysis process.

Steps 6 to 9 correspond to vacuum evacuation steps. During Step 6, Step 7, Step 8, and Step 9, the pressure in the first bed is reduced to 5.0 kPa-a to 60 kPa-a. In some aspects, the evacuation effluent corresponds to a counter-current flow, relative to the direction of flow in the first bed in Steps 1 to 4. The evacuation effluent generated during Steps 6 to 9 can also be compressed and recycled to the pyrolysis process. By recycling both the blowdown exhaust and the evacuation effluent, substantially all of the methane not included in the hydrogen-containing product is recycled back to the pyrolysis process for additional hydrogen production.

Step 10 corresponds to a third pressure equalization step. In Step 10, a fourth bed that is at a higher pressure is equalized with the first bed. At the start of the third pressure equalization step, the pressure in the first bed can be between 5.0 kPa-a to 60 kPa-a. The pressure in the fourth bed can be 350 kPa-a to 1000 kPa-a. After equalization, the pressure in both beds will roughly correspond to an average of the pressures prior to equalization. In some aspects, the pressure in the first bed and fourth bed after equalization can be 180 kPa-a to 500 kPa-a. In some aspects, the final pressure in both beds after equalization can correspond to a pressure that is 50% to 60% of the pressure in the fourth bed prior to the start of the third equalization step. In other words, a ratio of the pressure in the fourth bed at the end of the third equalization step to a pressure in the third bed prior to the start of the second equalization step is between 0.50 and 0.60. Because this is a pressure equalization step, the output flow from the fourth bed serves as the input flow to the first bed.

Step 11 corresponds to a fourth pressure equalization step. In Step 11, a fifth bed that is at a higher pressure is equalized with the first bed. At the start of the fourth pressure equalization step, the pressure in the first bed can be between 180 kPa-a to 500 kPa-a. The pressure in the fifth bed can be 500 kPa-a to 1500 kPa-a. After equalization, the pressure in the both beds will roughly correspond to an average of the pressures prior to equalization. In some aspects, the pressure in the first bed and fifth bed after equalization can be 350 kPa-a to 1000 kPa-a. Additionally or alternately, in some aspects, the final pressure in both beds after equalization can correspond to a pressure that is 60% to 80% of the pressure in the fifth bed prior to the start of the equalization step. In other words, a ratio of the pressure in the fifth bed at the end of the fourth equalization step to a pressure in the fifth bed prior to the start of the fourth equalization step is between 0.60 and 0.80. Because this is a pressure equalization step, the output flow from the fifth bed serves as the input flow to the first bed.

Finally, Step 12 corresponds to a re-pressurization step to prepare the first bed for the next cycle (i.e., the Step 1 adsorption step for making the hydrogen-containing product). In Step 12, a portion of the hydrogen-containing product (and/or a stream from another source that has a hydrogen content equal to or greater than the hydrogen-containing product) is used to re-pressurize the first bed to a pressure that is close to the pressure for performing the adsorption in Step 1 of the next cycle. In some aspects, all of the re-pressurization can be performed using the hydrogen-containing product. In other aspects, the hydrogen-containing product can be used to increase the pressure in the first bed to 85% or more of the target pressure for performing Step 1 of the process cycle, or 90% or more, or 95% or more, such as up to 100%. After reaching 85% or more of the target pressure (or 90% or more, or 95% or more), the pyrolysis effluent can then be used to increase the pressure in the first bed to the target pressure for performing Step 1 of a the next cycle.

Table 1 shows an example of a process cycle based on the above 12 steps. As an example of timing for the process cycle shown in Table 1, each step can last for roughly the same amount of time, such as 5 seconds. In some aspects, each step can last for 3 to 15 seconds.

TABLE 1
Sorption/Desorption VPSA Process Cycle Example

| Step | Bed 1 |
|---|---|
| 1 | Adsorption step 1 - co-current adsorption to make hydrogen- |
| | containing product |
| 2 | Adsorption step 2 - co-current adsorption to make hydrogen- |
| | containing product |
| 3 | First de-pressurize equalization with a second bed |
| 4 | Second de-pressurize equalization with a third bed |
| 5 | Blowdown to roughly atmospheric pressure; recycle |
| | blowdown exhaust to pyrolysis process |
| 6 | Exhaust to pressure below 60 kPa-a |
| 7 | Exhaust to pressure below 60 kPa-a |
| 8 | Exhaust to pressure below 60 kPa-a |
| 9 | Exhaust to pressure below 60 kPa-a |
| 10 | First re-pressurize equalization with a fourth bed |
| 11 | Second re-pressurize equalization with a fifth bed |
| 12 | Re-pressurize with hydrogen-containing product |

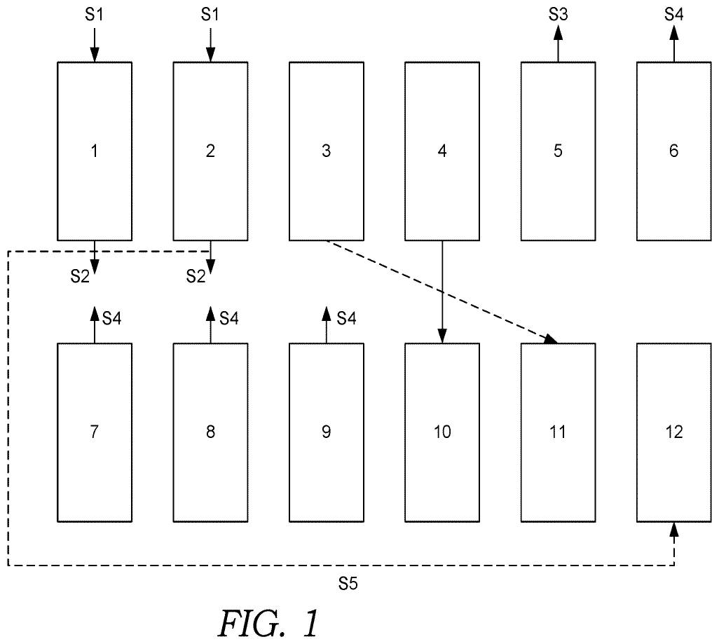

FIG. 1 shows a representation of a twelve bed system for performing the twelve step sorption/desorption cycle shown in Table 1. In FIG. 1, beds 1-12 are shown, and each bed is in one of the steps shown in Table 1. Thus, bed 1 in FIG. 1 is in Step 1 from Table 1, bed 2 is in Step 2, and so on through bed 12 being in Step 12. FIG. 1 also shows the connectivity for performing the de-pressurization and re-pressurization steps, as well as the connectivity for using a portion of the hydrogen-containing product from Step 1 and/or Step 2 for the re-pressurization in Step 12. As shown in FIG. 1, beds 3 and 11 are in fluid communication for performing the first de-pressurization step and the second re-pressurization step. Beds 4 and 10 are in fluid communication for performing the second de-pressurization step and the first re-pressurization step. Additionally,

In FIG. 1, S1 represents the pyrolysis effluent. S2 represents the hydrogen-containing product. S3 represents the blowdown exhaust. S4 represents the evacuation effluents. S5 represents a portion of the hydrogen-containing product that is used for the re-pressurization in Step 12.

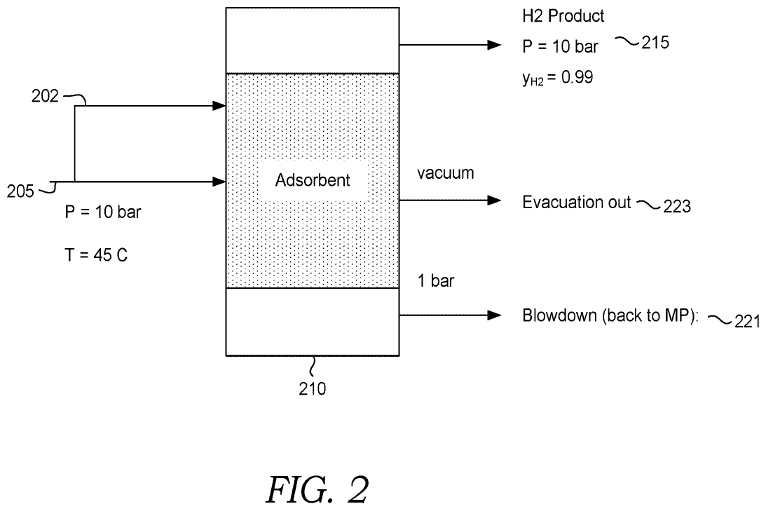

FIG. 2 shows an example of process flows for a sorbent bed that is part of a collection of beds for performing a vacuum pressure swing adsorption process. In FIG. 2, sorbent bed 210 corresponds to one bed from a plurality of beds that perform a vacuum pressure swing adsorption sequence. In the example shown in FIG. 2, the fresh feed input flow for sorbent bed 210 corresponds to pyrolysis effluent 205. A portion 202 of pyrolysis effluent 205 is also used during re-pressurization of sorbent bed 210. During the adsorption part of a process cycle, sorbent bed 210 receives pyrolysis effluent 205 and produces hydrogen-containing product stream 215. During product equalization steps, flows (not shown) can pass from sorbent bed 210 to another sorbent bed that is part of the configuration. During blowdown, the blowdown exhaust 221 can be pressurized and recycled back to the pyrolysis reaction (not shown). During evacuation, the evacuation exhaust 223 can optionally also be recycled back to the pyrolysis reaction (after pressurization).

As an example of process conditions that can be used for a sorbent bed such as the sorbent bed shown in FIG. 2, the pyrolysis effluent 205 can be passed into the sorbent bed 210 at a pressure of roughly 10 bar (1000 kPa). This can allow for formation of an H₂ product stream 215 that is also roughly at 10 bar (1000 kPa). In some aspects, such an H₂ product stream 215 can have an H₂ content of 98.0 vol % or more, or 99.0 vol % or more. The blowdown exhaust 221 can be at a pressure of roughly 1 bar (100 kPa). The evacuation exhaust 223 can be at a pressure below 100 kPa that is used for a vacuum pressure swing adsorption cycle.

### Separation of Pyrolysis Effluent—Pressure Swing Adsorption Cycle

As an alternative to using vacuum pressure swing adsorption, a pressure swing adsorption cycle can be used to provide improved recovery of hydrogen while maintaining a target purity of 98.0 vol % or more, or 99.0 vol % or more, such as up to 99.9 vol % or possibly still higher. One of the advantages of pressure swing adsorption is that the additional cost and equipment for reducing sorbent environments to pressures below 90 kPa-a is avoided.

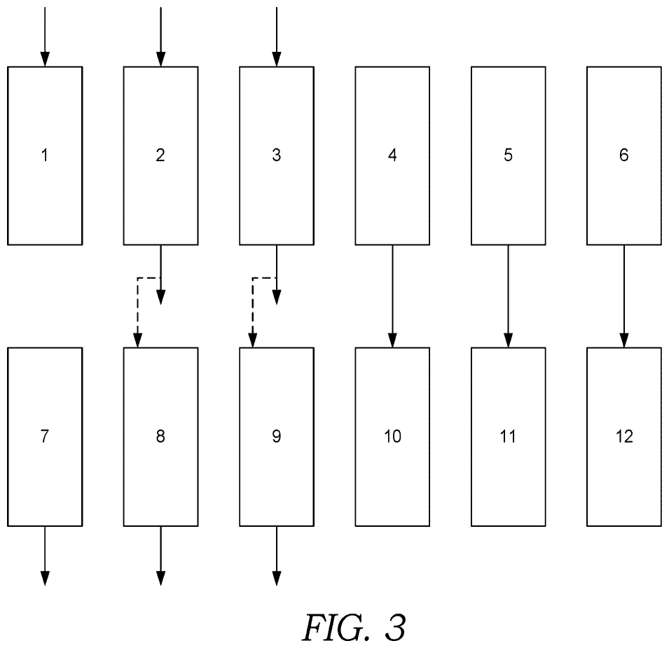

An example of a twelve step process cycle will be illustrated using a configuration involving ten sorbent beds, with the sorbent beds being roughly comparable in size and the vessels containing the sorbent beds being roughly comparable in volume. This process is further illustrated in FIG. 3. However, it is understood that any convenient number of sorbent beds can be used that is consistent with performing the cycle. In the following example, the lengths of certain steps and/or groups of steps are the same, to allow for synchronization. It is understood that with a different number of sorbent beds, other process synchronization cycles could be developed.

In this example, Step 1 corresponds to a co-current pressurization step. The gas flow in this step enters the bed from the same end of the bed as Step 2, where adsorption will occur for production of high purity hydrogen-containing gas. The pyrolysis effluent is used as the input flow for the co-current pressurization. This step increases the pressure in the sorbent environment to the target pressure for performing the adsorption step.

Step 2 corresponds to the adsorption step, where the sorbent is exposed to a flow of the pyrolysis effluent. This produces a sorbent with an increased loading of methane and carbon oxides, and an adsorption effluent that has an H₂ (hydrogen) content of 98.0 vol % or more, or 99.0 vol % or more. This step is performed at a pressure between 500 kPa-a and 1500 kPa-a. It is noted that a typical pressure for a pyrolysis effluent produced by a pyrolysis process is between roughly 100 kPa-a and 1000 kPa-a. In some aspects, no compression may be needed for the pyrolysis effluent. In other aspects, compression can be performed to increase the pressure of the pyrolysis effluent to a target pressure for the start of the separation process.

In the adsorption step corresponding to Step 2, various temperatures can be used. Temperatures near room temperature can be convenient for processing, but lower temperatures can potentially provide a higher purity adsorption effluent. In some aspects, the temperature can be between −50° C. and 40° C. The velocity of gas in the sorption environment during the adsorption steps can vary depending on the configuration of the sorbent environment. In some aspects, the gas velocity during the sorption steps can be roughly between 0.01 m/s and 1.0 m/s. The resulting adsorption effluent having an H₂ content of 98.0 vol % or more is produced at a pressure similar to the pressure during the adsorption step.

It is noted that the hydrogen-containing product formed during Step 2 can include a reduced or minimized amount of the methane present in the pyrolysis effluent. In various aspects, the hydrogen-containing product can contain 5.0 mol % or less of the methane that was contained in the pyrolysis effluent, or 4.0 mol % or less, such as down to 1.0 mol % or possibly still less. Additionally or alternately, the hydrogen-containing product can contain a reduced or minimized amount of carbon oxides (CO and CO₂). In various aspects, the hydrogen-containing product can contain 0.2 mol % or less of the carbon oxides that were contained in the pyrolysis effluent, or 0.1 mol % or less, such as down to having substantially no carbon oxide content.

Steps 3, 4, and 5 correspond to pressure equalization steps for reducing the pressure in the first bed while increasing the pressure in other beds. In each of Step 3, Step 4, and Step 5, the first bed is placed in fluid communication with different beds that are at different (lower pressure) steps in the process cycle. In each of Step 3, Step 4, and Step 5, the pressure from the first bed is allowed to equalize with the pressure in another bed. In some aspects, this pressure equalization is performed by connecting only one end of the first bed with one end of the second bed. Pressurizing using a flow only from one end of the pressurized bed can assist with improving the purity of the H₂ stream generated by the separation process. This is in contrast to a pressure equalization process where pressure equalization is performed using gas flows from both ends of the pressurized bed.

The pressure equalization steps allow the pressure in the first bed to be reduced while a) reducing or minimizing hydrogen included in purge gas and b) reducing or minimizing the amount of additional pressurization that will be needed in a co-current pressurization step to return the other beds to the target pressure for performing adsorption. After equalization, the pressure in the both beds involved in the equalization step will roughly correspond to an average of the pressures prior to equalization.

At the start of Step 3, the first bed will be at a pressure between 600 kPa-a and 1500 kPa-a, while the second bed will be at a pressure between 350 kPa-a and 800 kPa-a. In some aspects, the pressure in the first bed and second bed after equalization can be 500 kPa-a to 1100 kPa-a. Additionally or alternately, in some aspects, the final pressure in both beds after equalization can correspond to a pressure that is 60% to 80% of the pressure in the first bed prior to the start of the equalization step. In other words, a ratio of the pressure in the first bed at the end of the first equalization step to a pressure in the first bed prior to the start of the first equalization step is between 0.60 and 0.80. Because this is a pressure equalization step, the output flow from the first bed serves as the input flow to the second bed.

At the start of Step 4, the first bed will be at a pressure between 500 kPa-a and 1100 kPa-a, while the third bed will be at a pressure between 220 kPa-a and 500 kPa-a. In some aspects, the pressure in the first bed and third bed after equalization can be 350 kPa-a to 800 kPa-a. Additionally or alternately, in some aspects, the final pressure in both beds after equalization can correspond to a pressure that is 60% to 80% of the pressure in the first bed prior to the start of the equalization step. In other words, a ratio of the pressure in the first bed at the end of the first equalization step to a pressure in the first bed prior to the start of the first equalization step is between 0.60 and 0.80. Because this is a pressure equalization step, the output flow from the first bed serves as the input flow to the third bed.

At the start of Step 5, the first bed will be at a pressure between 350 kPa-a and 800 kPa-a, while the fourth bed will be at a pressure between 90 kPa-a and 120 kPa-a. In some aspects, the pressure in the first bed and fourth bed after equalization can be 220 kPa-a to 500 kPa-a. Additionally or alternately, in some aspects, the final pressure in both beds after equalization can correspond to a pressure that is 60% to 80% of the pressure in the first bed prior to the start of the equalization step. In other words, a ratio of the pressure in the first bed at the end of the first equalization step to a pressure in the first bed prior to the start of the first equalization step is between 0.60 and 0.80. Because this is a pressure equalization step, the output flow from the first bed serves as the input flow to the third bed.

Step 6 corresponds to a blowdown step, to reduce the pressure in the first bed to roughly ambient pressure (roughly 100 kPa-a). Because pressure is being released, no input flow is needed for the blowdown step. The blowdown step generates a blowdown exhaust. In some aspects, the blowdown exhaust can correspond to a counter-current flow, relative to the direction of flow in the first bed in Step 2. Due to the reduction in pressure, the methane and carbon oxides adsorbed in the sorbent bed are at least partially desorbed during the blowdown. Thus, in addition to containing H₂ the blowdown exhaust corresponds to a stream with an increased content of methane and CO₂ relative to the composition of the pyrolysis effluent. In various aspects, blowdown exhaust can contain 20 vol % to 50 vol % of methane, relative to the volume of the blowdown exhaust. This blowdown exhaust can be compressed and recycled back to the pyrolysis process.

Step 7 is a purge step. During Step 7, a portion of the hydrogen-containing product stream is used as a purge gas to remove an additional portion of the CO₂ and CH₄ that is adsorbed on the sorbent. After compression, the purge stream can be recycled to the methane pyrolysis reactor.

It is noted that in order to provide a synchronized process, the combined time for Step 6 and Step 7 can be the same as the combined time as Step 1 and Step 2. As an example, Step 1 and Step 6 can have the same length, while Step 2 and Step 7 have the same length. In some aspects, the adsorption in Step 2 and the blowdown in Step 7 can be longer than Step 1 and Step 6, such as Step 2 and Step 7 being twice as long as Step 1 and Step 6. More generally, the length of Step 2 and Step 7 can be between 1.5 to 3.0 times as long as the length of Step 1 and Step 6.

Steps 8 to 10 correspond to pressure equalization steps to re-pressurize bed 1. Steps 8 to 10 are mirror images of Steps 3 to 5, but with the first bed as the low pressure bed and the other beds as the higher pressure beds. For synchronization, Step 8 can have the same time length as Step 5, Step 9 can have the same time length as Step 4, and Step 10 can have the same time length as Step 3. Optionally, each of Step 3, Step 4, and Step 5 can be of substantially equal length. Optionally, Step 1 can be of substantially the same length as at least one of Step 3, Step 4, and Step 5.

Table 2 shows an example of a process cycle based on the above 10 steps. As an example of timing for the process cycle shown in Table 2, each step can last for roughly 10 seconds, with the exception of Step 2 and Step 7, which can last for 20 seconds. In some aspects, each step can last for roughly 5 to 20 seconds, with the exception of Step 2 and Step 7, which can last for 1.5 time to 3.0 times longer than the other steps.

TABLE 2
Sorption/Desorption PSA Process Cycle Example

| Step | Bed 1 |
|---|---|
| 1 | Re-pressurization - co-current re-pressurization with |
| | pyrolysis effluent input flow |
| 2 | Adsorption step - co-current adsorption using pyrolysis |
| | effluent input flow to make hydrogen-containing product |
| 3 | First de-pressurize equalization with a second bed |
| 4 | Second de-pressurize equalization with a third bed |
| 5 | Third de-pressurize equalization with a fourth bed |
| 6 | Blowdown (counter-current) to roughly atmospheric |
| | pressure; recycle blowdown exhaust to pyrolysis process |
| 7 | Counter-current purge using hydrogen-containing product |
| | as input flow |
| 8 | First re-pressurize equalization with a fifth bed |
| 9 | Second re-pressurize equalization with a sixth bed |
| 10 | Third re-pressurize equalization with a seventh bed |

FIG. 3 shows a representation of a twelve bed system for performing the twelve step sorption/desorption cycle shown in Table 2. In FIG. 3, beds 1-12 are shown, and each bed is in one of the steps shown in Table 2. Thus, bed 1 in FIG. 3 is in Step 1 from Table 2, beds 2 and 3 are in Step 2, beds 4 to 6 are in Steps 3 to 5, bed 7 is in Step 6, beds 8 and 9 are in Step 7, and beds 10-12 are in Steps 8-10. FIG. 3 also shows the connectivity for performing the de-pressurization and re-pressurization steps, as well as the connectivity for using a portion of the hydrogen-containing product from Step 1 and/or Step 2 for the re-pressurization in Step 12.

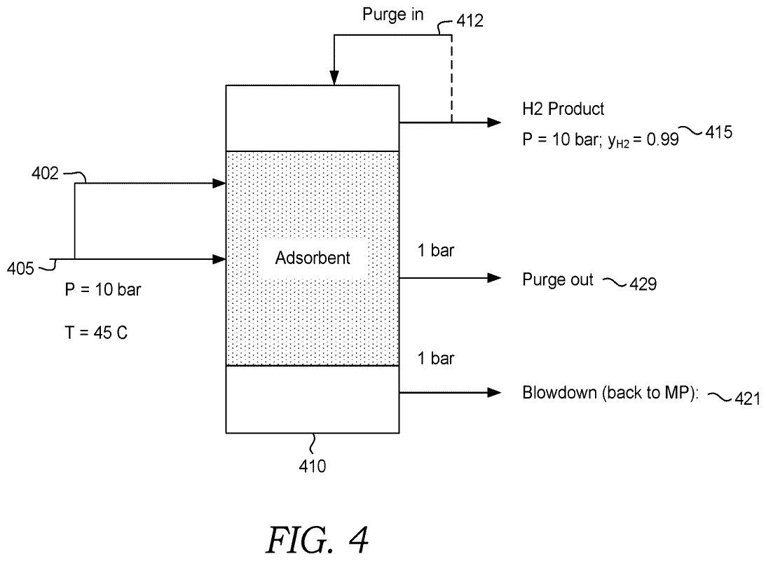

FIG. 4 shows an example of the process flows for a sorbent bed that is part of a collection of beds for performing a pressure swing adsorption process. In FIG. 4, sorbent bed 410 corresponds to one bed from a plurality of beds that perform a vacuum pressure swing adsorption sequence. In the example shown in FIG. 4, the fresh feed input flow for sorbent bed 410 corresponds to pyrolysis effluent 405. A portion 402 of pyrolysis effluent 405 is also used during re-pressurization of sorbent bed 410. During the adsorption part of a process cycle, sorbent bed 410 receives pyrolysis effluent 405 and produces hydrogen-containing product stream 415. During product equalization steps, flows (not shown) can pass from sorbent bed 410 to another sorbent bed that is part of the configuration. During blowdown, the blowdown exhaust 421 can be pressurized and recycled back to the pyrolysis reaction. During purging, a portion 412 of hydrogen-containing product 415 can be used as the purge input flow to generate purge output 429.

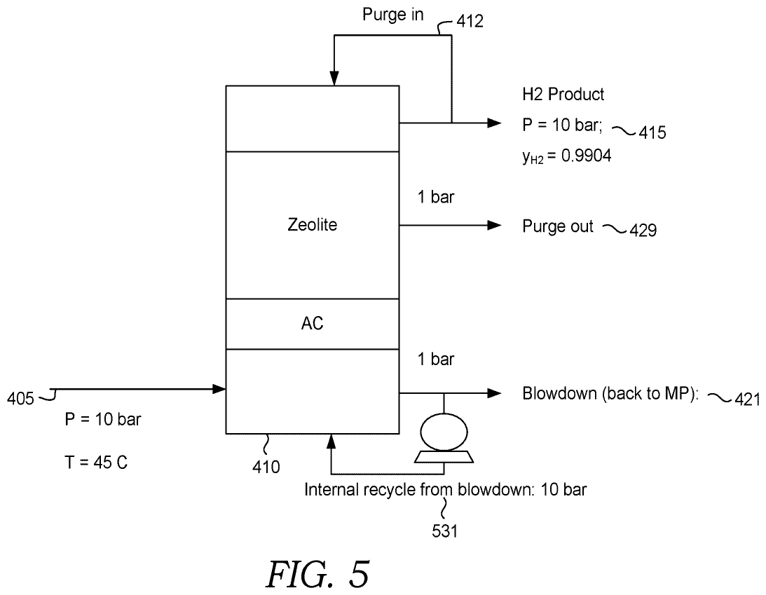

FIG. 5 shows an alternative example of process flows for a sorbent bed that is part of a collection of beds for performing a pressure swing adsorption process. The configuration shown in FIG. 5 includes an additional recycle to improve hydrogen recovery. In FIG. 5, instead of sending all of blowdown exhaust 421 to the pyrolysis reactor, a portion 531 of the blowdown exhaust is recycled to the sorbent bed 410.

### Adsorbent Beds—Packed Beds and Structured Adsorbents

In various aspects, a VPSA process or PSA process can be performed using a plurality of sorbent beds working in conjunction to provide a continuous process for separating hydrogen from a pyrolysis effluent. In some aspects, a packed bed of sorbent particles can be used. The particles can be composed entirely of a sorbent material, or the particles can correspond to a sorbent material supported on a support.

In other aspects, a structured adsorbent contactor can be used, such as a contactor with sorbent coated on interior walls of channels in the contactor. In such a structured adsorbent contactor, the channels can optionally be substantially parallel to one another. A monolith is an example of a structured adsorbent contactor that can have substantially parallel channels. An advantage of a structured adsorbent contactor is that the void volume for the sorbent can be reduced or minimized. In conventional packed beds, sufficient void volume needs to be present so that a gas (such as a pyrolysis effluent) can flow through the packed bed without having excessive pressure drop. Flowing the gas through the packed bed allows the gas to contact the sorbent material, resulting in selective sorption of one or more components from the gas flow. However, for regularly shaped particles such as spheres, there are limits on the potential packed density of the particles. This can alternatively be described as regularly shaped particles having a minimum void volume within the packed bed. Structured beds can reduce the void fraction for the adsorbent bed while still allowing good contact between sorbent and gas flow and reducing or minimizing pressure drop.

For a structured adsorbent, such as a monolith or other contactor having substantially parallel channels, the void fraction can be reduced relative to a conventional packed bed. The void fraction is defined as the percentage of the volume through which inlet or outlet let gas can flow. That is the volume of the adsorption bed less the volume of adsorbent particles, binding material particles and all possible support structures. This definition is applicable to both packed bed as well as structured adsorbent contactors. The micropore and possibly mesopore volume within the adsorbent particles themselves in which adsorption takes place is not considered part of the void volume. However, porosity within the adsorbent layer or a pellet is part of the void volume.

In some aspects, a monolith (or other contactor having substantially parallel channels) can have a void fraction of 70% or less, or 60% or less, or 50% or less, or 40% or less, or 36% or less, or 34% or less, or 32% or less, such as down to 25% or possibly still less.

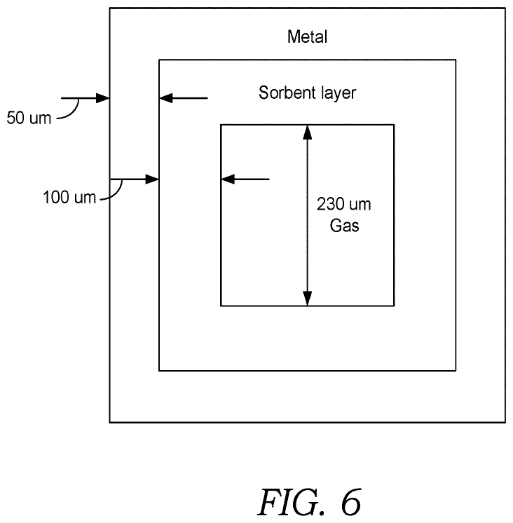

FIG. 6 shows an example of a cell from a structured adsorbent corresponding to a monolith with sorbent material coated on the interior walls of the monolith channels. In the example shown in FIG. 6, a channel from a monolith with square channels is represented. A sorbent layer is coated on the interior walls of the channel, leaving a hole in the middle. In the example shown in FIG. 6, the monolith corresponds to a monolith that includes 2500 channels per square inch. The wall thickness for the monolith channels is roughly 50 micrometers. The sorbent layer coated on the interior surfaces of the channels has a thickness of roughly 100 micrometers. This leaves a square opening with a side length of roughly 230 micrometers in the center of the channel. The central opening allows gas to pass through the monolith with a reduced pressure drop while still exposing the gas flow to the sorbent material. However, depending on the thickness and porosity of the sorbent layer, the overall void volume for the monolith structure can actually be lower than the void volume for a packed bed of spheres.

FIG. 6 can be used to illustrate the calculation of the void fraction for a monolith. For the sample monolith cell shown in FIG. 6, the wall thickness corresponds to volume that gas cannot pass through. The square opening shown in FIG. 6 corresponds to volume that is open. The sorbent layer has a porosity, so that a portion of the sorbent layer contributes to the void fraction. Based on the dimensions shown in FIG. 6, the wall thickness corresponds to 32% of the volume (or a fraction of 0.32), the sorbent layer corresponds to 47% of the volume, and the open area in the middle corresponds to 21% of the volume. To illustrate the void fraction calculation, as an example, the porosity of the sorbent layer can correspond to roughly 25% of the volume of the sorbent layer. Based on this value, the void fraction for the structured adsorbent can be calculated as the open area (0.21) plus the porosity of the sorbent layer (0.47 times 0.25), to arrive at a void fraction for the structured adsorbent of 0.335.

Depending on the aspect, the porosity of the sorbent layer on interior channels of a monolith can be between 0.15 to 0.40, or 0.15 to 0.35, or 0.15 to 0.30, or 0.20 to 0.40, or 0.20 to 0.35, or 0.20 to 0.30.

The sorbent material for the sorbent bed can be either a kinetically selective adsorbent or an equilibrium selectivity adsorbent. Examples of kinetically selective adsorbents include, but are not limited to, titanoslicate ETS-4 or carbon molecular sieve (CMS) sorbents. Such sorbents have kinetic selectivity for adsorption of N₂ relative to CH₄. However, due to the low concentration of N₂ in a typical pyrolysis effluent, such an approach would require significant amount of material due to limitations on adsorbent capacity for N₂.

For adsorbents based on equilibrium selectivity, working capacity towards CH₄ and CH₄/N₂ selectivity are typically the most important considerations. Examples of materials with suitable working capacity and selectivity can include, but are not limited to, activated carbons, silica gel, and siliceous zeolitic materials. For example, siliceous MFI (ZSM-5) zeolite exhibits reasonable selectivity between CH₄ and N₂ on the order of 3-4, and working capacity on the order of ˜0.3 mmol/g. Another example is FER zeolite that features comparable methane capacity and CH₄/N₂ selectivity.

In some aspects, a stacked bed of adsorbents can be used, such as an initial portion of activated carbon for sorption of CO₂ and CH₄, followed by a zeolitic adsorbent that has high selectivity for sorption of N₂ and CO. Examples of zeolitic adsorbents for use in such a stacked bed arrangement can include, but are not limited to, zeolite 13X and MFI framework structure zeolites.

### Pyrolysis Process

In various aspects, the separations described herein can be performed on a pyrolysis effluent generated from any convenient type of pyrolysis process that produces a pyrolysis effluent containing 60 vol % or more of hydrogen, or 70 vol % or more, or 75 vol % or more, or 80 vol % or more, or 85 vol % or more, such as up to 99 vol % or possibly still higher. Various types of pyrolysis reactors are available. Optionally, the pyrolysis effluent can also contain N₂, such as 7.0 vol % or less of N₂, or 5.0 vol %, or 3.0 vol %, such as down to 0.1 vol % or possibly still lower. A fluidized bed process is described herein as an example, but it is understood that other pyrolysis configurations can be used.

Fluidized bed pyrolysis of methane, natural gas, or another suitable hydrocarbon-containing feed can be performed at a temperature of 1000° C. to 1600° C., or possibly still higher temperatures. The temperature in the pyrolysis reactor can be between 100 kPa-a to 1000 kPa-a, or 200 kPa-a to 1000 kPa-a. The feed can be any convenient feed that includes 50% or more of C₁-C₄ alkanes, or 75 vol % or more, or 95 vol % or more, such as up to substantially all of the feed corresponding to C₁-C₄ hydrocarbons. Coke particles can be a convenient particle for forming the fluidized bed, but other particles such as sand could also be used. The residence for the hydrocarbon-containing feed in the fluidized bed can range from 0.1 seconds to 500 seconds, or 0.1 seconds to 100 seconds, or 1.0 seconds to 100 seconds. The flow rate for the hydrocarbon-containing feed can be sufficient to provide fluidization for the bed. Optionally, a plurality of fluidized beds can be used, such as the configuration shown in U.S. Patent Application Publication 20210331918.

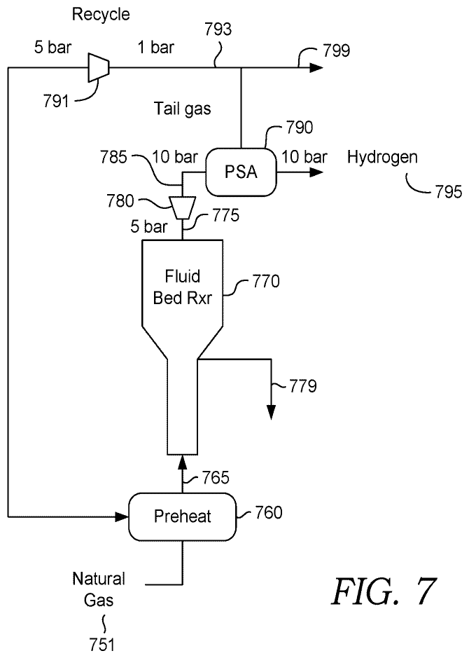

FIG. 7 shows an example of a system configuration for performing pyrolysis and separating hydrogen from the pyrolysis effluent. In FIG. 7, a natural gas feed 751 (or other hydrocarbon-containing feed) is pre-heated 760 to increase the temperature of the feed prior to entering the pyrolysis reactor. The pre-heated effluent 765 is then passed into pyrolysis reactor 770, which corresponds to a fluidized bed reactor in the example shown in FIG. 7. This results in production of a pyrolysis effluent 775. A portion of the pyrolysis coke (carbon generated during the pyrolysis reaction) can also be removed 779 from the pyrolysis reactor.

In the example shown in FIG. 7, the pyrolysis reactor is operated at roughly 500 kPa-a. In this example, a compressor 780 is used to increase the pressure of pyrolysis effluent 775 to form compressed pyrolysis effluent 785 at a pressure of 1000 kPa-a. In other aspects, the pressure of the pyrolysis effluent can be increased to any convenient target pressure between 500 kPa-a to 1500 kPa-a. Alternatively, compressor 780 can be optional if pyrolysis reactor 770 is operated at a sufficiently high pressure.

The optionally compressed pyrolysis effluent 785 is then passed into a separation stage 790 to separate a hydrogen-containing product stream 795 from the optionally compressed pyrolysis effluent 785. Separation stage 790 can correspond to a plurality of swing adsorption beds, such as one of the twelve bed configurations shown in FIG. 1 or FIG. 3, or another convenient arrangement and number of beds. The hydrogen-containing product stream 795 can be generated at a pressure similar to the pressure of the optionally compressed pyrolysis effluent 785. The separation stage 790 can correspond to a PSA or VPSA separation stage. The separation stage 790 can also generate a tail gas 793 that includes a majority of the methane from the pyrolysis effluent 775 and/or the optionally compressed pyrolysis effluent 785. The tail gas 793 can be at a relatively low pressure, such as a pressure between 90 kPa-a and 150 kPa-a for a PSA process, or a pressure of 10 kPa-a to 150 kPa-a (or 10 kPa-a to 90 kPa-a) for a VPSA process.

It is noted that tail gas 793 can correspond to a mixture of bed exhausts and/or purge streams that may be at different pressures, as the tail gas can be formed from several different steps in a process cycle. The different bed exhausts and/or purge streams can optionally be compressed so that all exhausts/streams are at roughly the same pressure prior to mixing, or the exhausts/streams can be mixed to form a mixture and then compressed. The compression of the tail gas 793 can be performed by recycle compressor 791, which forms a compressed recycle stream at roughly the pressure of the pyrolysis process 770. A purge stream 799 can also be formed from tail gas 793. Purge stream 799 allows compounds such as N₂ that are not removed or consumed during the pyrolysis and separation processes to be purged from the system.

### EXAMPLES

A process model was used to simulate the performance of various sorbent bed configurations for both VPSA and PSA processes. For the VPSA model calculations described below, the process cycle illustrated in FIG. 1 was used. The sorbent beds included a monolith with channels similar to those shown in FIG. 6. The sorbent material on the interior walls of the channels was an MFI zeotype material.

For the PSA model calculations described below, the process cycle illustrated in FIG. 3 was used. The sorbent beds corresponded to packed beds.

For the PSA model calculations, packed bed size was chosen to have bed diameter of 3.5 m and bed length of 6 m. For the VPSA calculations where a monolith was used, a monolith providing roughly the same volume as the packed bed volume was used.

For all of the calculations, a model pyrolysis effluent stream was used. The pyrolysis effluent stream has a pressure of roughly 1,000 kPa-a (10 bar) and a temperature of 45° C. The composition of the stream (on a dry basis) is 90.9 mol % H₂, 8.0 mol % CH₄, 0.8 mol % N₂, and 0.3 mol % CO₂.

### Example 1—VPSA Process Cycle

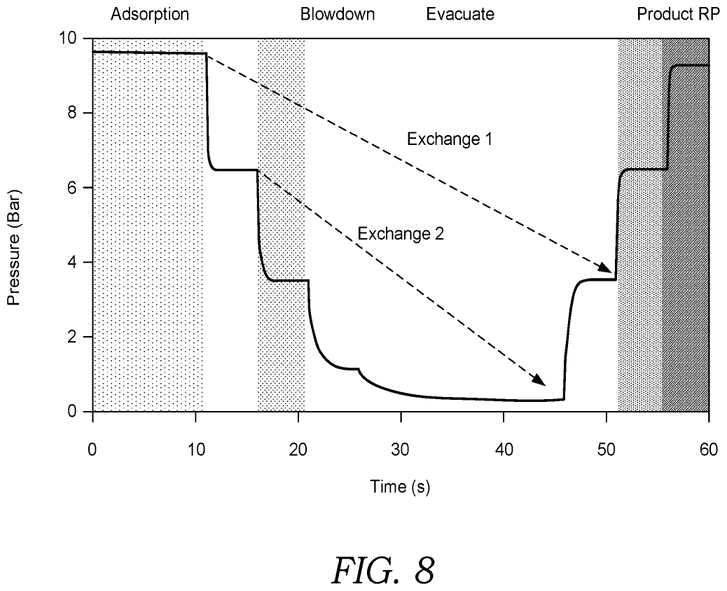

A vacuum pressure swing adsorption (VPSA) process was simulated using a twelve bed configuration similar to FIG. 1 and a process cycle according to Table 1 above. FIG. 8 shows a representation of how the pressures in the first bed vary during the course of the 12 step process illustrated in Table 1 and FIG. 1. As shown in FIG. 8, in the simulation, the initial adsorption to generate the hydrogen-containing product in Steps 1 and 2 was performed at roughly 1000 kPa-a. The pressure equalization or exchange steps in Steps 3 and 4 then reduced the pressure in the bed to 650 kPa-a (Step 3) and then 340 kPa-a (Step 4). The blowdown in Step 5 then reduced the pressure to 100 kPa-a. In evacuation Steps 6 to 9, the pressure is reduced in the bed to 10 kPa-a to 20 kPa-a. It is noted that the final pressure of roughly 10 kPa-a is not initially achieved during Step 6. Instead, the final pressure of roughly 10 kPa-a is approached during the course of the evacuation. Steps 10 and 11 are pressure equalization steps that return the pressure to 340 kPa-a (Step 10) and 650 kPa-a (Step 11). Finally, in Step 12, pyrolysis effluent is used to increase the pressure to roughly 930 kPa-a prior to the start of producing the hydrogen-containing product stream.

Table 3 shows the compositions of the modeled gas flows labeled S1 to S5 in FIG. 1. In Table 3, N/N_{FEED} is the ratio of the number of moles of gas in a stream relative to the number of moles of gas in the input pyrolysis effluent stream. Thus, N/N_{FEED} is 1.0 for stream S1, which corresponds to the input flow. The content of the recycle stream returned to the pyrolysis reactor is also shown.

TABLE 3
Composition of Streams During VPSA Process

| | | | Mole percent | | | |
|---|---|---|---|---|---|---|
| Stream | N/N_{FEED} | P(bar) | Methane | Nitrogen | Hydrogen | CO2 |
| S1 | 1.00 | 10.00 | 8.0% | 0.8% | 90.9% | 0.3% |
| S2 | 0.82 | 9.30 | 0.7% | 0.3% | 99% | 0.0% |
| S3 | 0.13 | 1.00 | 33.5% | 2.2% | 63.1% | 1.2% |
| S4 | 0.06 | 0.20 | 53.3% | 3.7% | 40.6% | 2.4% |
| S5 | 0.11 | 9.30 | 0.7% | 0.3% | 99% | 0.0% |
| Recycle | 0.19 | 5.00 | 40.6% | 2.7% | 56.7% | 1.6% |

Table 4 shows the ratio of moles of each type of gas in the hydrogen-containing product stream S2 versus the moles of each type of gas in the input stream S1.

TABLE 4
Ratio of Gases in Product Stream and Input Stream
N_{S2}/N_{S1}

| | |
|---|---|
| Hydrogen | 0.89 |
| Methane | 0.074 |
| Nitrogen | 0.33 |
| CO₂ | 0.034 |

As shown in Tables 3 and 4, in the example process that was modeled, the recycle molar flow rate to the pyrolysis reactor was 19% of the total number of moles of gas which was fed to the VPSA process through stream S1. The hydrogen recovery is 89%, meaning 89% of the moles of hydrogen sent to the VPSA process in stream S1 are passed into the hydrogen-containing product stream S2. This high level of recovery of the hydrogen in input flow S1 is achieved while also producing a hydrogen-containing product S2 that has an H₂ content of 99 mol %. Similarly, the methane recovery is 92.6%, meaning 92.6% of the methane fed to the VPSA process in S1 is captured and recycled back to the pyrolysis reactor in S5.

Of the nitrogen (N₂) fed to the VPSA in stream S1, 33% passes through the bed and exits with the hydrogen-containing product gas S2, while the remaining nitrogen is recycled back to the pyrolysis reactor. On the other hand, only 3.4% of CO₂ in stream S1 exits with stream S2, with the remaining 96.6% being recycled back to the pyrolysis reactor.

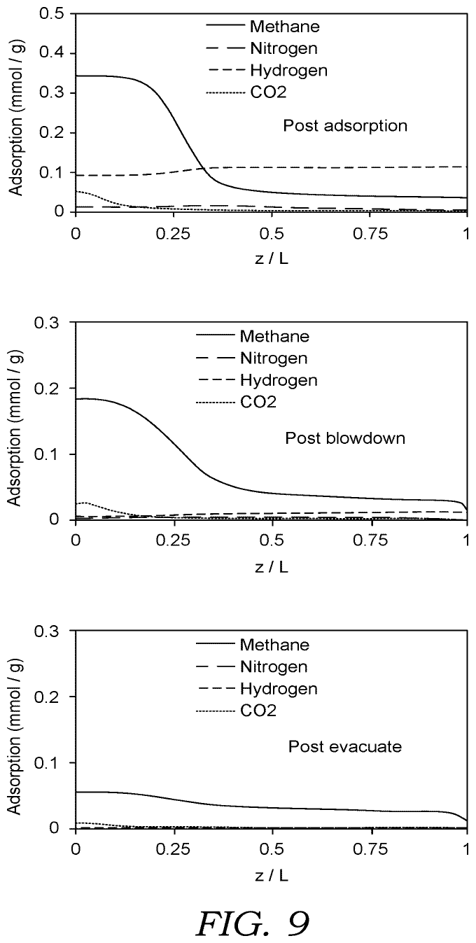

The adsorption profiles within the adsorption step were also characterized, and are provided in FIG. 9. In FIG. 9, adsorption refers to mmol of species adsorbed per gram of adsorbent MFI zeolite. The x axis represents the axial dimension of the adsorption bed with z=0 being the feed side of the bed, and z=L being the product side. The three adsorption profile snapshots show the state of the bed at the conclusion of the adsorption step (end of Step 2), blowdown step (end of Step 5), and the final evacuation step (end of Step 9).

As shown in FIG. 9, at the end of the adsorption step, the amount of H₂ absorbed by the bed is relatively constant throughout the length of the bed. By contrast, the methane content is substantially higher in the early part of the bed, with the methane content of the bed dropping close to 0 roughly halfway through the bed. This indicates that the bed has substantial loading remaining for additional methane adsorption. This is desirable, as it means for the process cycle modeled, the bed was far from saturated relative to the amount of methane in the input flow to the bed during adsorption. The bed length and/or the adsorption cycle time can be adjusted if the adsorbed methane concentration profile within the bed is too close to saturation for a given combination of bed length, sorbent, and step length. The amount of adsorbed N₂ CO₂ is small. The amount of adsorbed CO₂ is also small, but there is a noticeable amount of CO₂ adsorbed in the initial portion of the bed.

At the end of the blowdown step, the adsorbed concentration profiles for both CO₂ and CH₄ are similar to the end of the adsorption step. This indicates that merely reducing the pressure from the adsorption pressure of 1000 kPa-a to the blowdown pressure of 100 kPa-a, in the absence of a purge gas, did not result in substantial release of either CO₂ or CH₄. However, substantially all of the H₂ adsorbed by the bed is removed by the end of the blowdown process.

At the end of the evacuation steps, substantially all of the CO₂ is desorbed. There is a baseline level of CH₄ still adsorbed to the bed. However, this does not pose an issue, as this baseline level of CH₄ will substantially remain adsorbed to the bed during the adsorption step in the next process cycle.

### Example 2—Examples of PSA Process Cycles

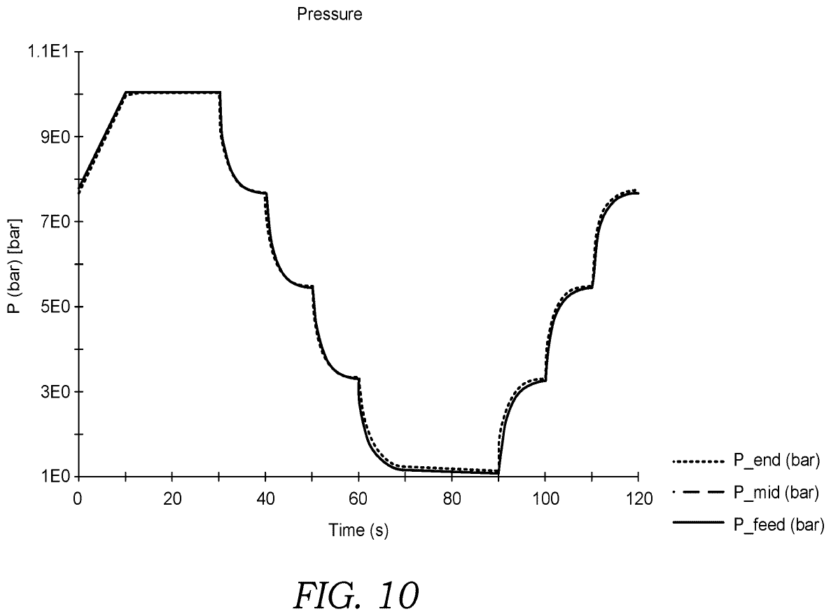

A series of different adsorbents, including combinations (stacked beds) of adsorbents, were used to model pressure swing adsorption (PSA) processes using the empirical modeling tool. The PSA processes were simulated using a twelve bed configuration similar to FIG. 3 and a process cycle according to Table 2 above. FIG. 10 shows a representation of how the pressures in the first bed vary during the course of the 10 step process illustrated in Table 2 and FIG. 3. As shown in FIG. 10, in the simulation, the initial co-current re-pressurization using the input feed (pyrolysis effluent) in Step 1 increased the pressure from roughly 770 kPa-a to the adsorption pressure of roughly 1000 kPa-a. The adsorption to generate the hydrogen-containing product in Step 2 was performed at roughly 1000 kPa-a. The pressure equalization or exchange steps in Steps 3, 4, and 5 then reduced the pressure in the bed to 770 kPa-a (Step 3), 560 kPa-a (Step 4), and then 340 kPa-a (Step 5). The blowdown in Step 6 then reduced the pressure to 100 kPa-a. The roughly 100 kPa-a pressure was maintained during the purge in Step 7. Steps 8 to 10 are pressure equalization steps to raise the pressure in the bed to 340 kPa-a (Step 8), 560 kPa-a (Step 9), and then to 770 kPa-a (Step 10) prior to the pressurization step at the beginning of the next process cycle.

Table 5 shows results from modeling of PSA processes using various adsorbents in the sorbent beds. In Table 5, the Cycle column indicates if any changes were made relative to the bed configuration and conditions shown in FIG. 4. For example, Case 2 was performed using the configuration shown in FIG. 5, while Case 4 was actually a VPSA process according to the configuration shown in FIG. 2, but with a packed bed of activated carbon (AC). Case 4 also used the 12 step process described in FIG. 1 and Table 1. “H₂ recov” is the molar percentage of H₂ in the hydrogen-containing product relative to the amount of H₂ in the input flow (pyrolysis effluent). “CH₄ rec” is the molar percentage of methane recycled back to the pyrolysis reactor relative to the amount of methane in the input flow. N₂ rejection is the molar percentage of N₂ that exits with the hydrogen-containing product relative to the total amount of N₂ in the input flow.

TABLE 5
Results from Modeled Processes

| | | | H₂ | Purge out | CH4 | N2 | Productivity |
|---|---|---|---|---|---|---|---|
| Case | Cycle | Material | recov. | direction | rec. | rejection | (kmol/hr/m³) |
| 1 | PSA | AC + 13X | 77% | Purge to | 92% | 9% | 6.2 |
| | | | | reactor | 86% | 15% | |
| | | | | purge to fuel | | | |
| 2 | PSA with | AC + 13X | 88% | Purge to | 92% | 12% | 4.8 |
| | inter. | | | reactor | 61% | 43% | |
| | recycle | | | purge to fuel | | | |
| 3 | PSA | AC | 71% | Purge to | 93% | 12% | 4.3 |
| | | | | reactor | 83% | 19% | |
| | | | | purge to fuel | | | |
| 4 | PVSA | AC | 73% | Evac. to | 93% | 16% | 7.6 |
| | (0.2 bar) | | | reactor | 57% | 44% | |
| | | | | Evac. to fuel | | | |
| 5 | PSA | MFI | 73% | Purge to | 93% | 10% | 4.6 |
| | | | | reactor | | | |
| | | | | purge to fuel | 83% | 17% | |

In Table 5, two dispositions are shown for the purge output stream from the bed. The first disposition is to recycle the purge stream to the reactor. The second disposition is to use the purge stream as a fuel.

The results shown in Table 5 are discussed in connection with each case. Cases 1, 3, and 5 have similar configurations and are described first.

Case 1—PSA, Stacked bed of activated carbon and zeolite 13X. Blowdown and purge pressure are atmospheric. Activated carbon layer length is 0.5 m and the zeolite layer length is 5.5 m. Table 6 lists the calculated stream flowrates and compositions for Case 1. The column V/V_{FEED} refers to the ratio of stream molar flow rate to that of feed stream.

TABLE 6
Compositions and Flow Rates for Case 1

| | Flowrate | | | | | |
|---|---|---|---|---|---|---|
| | (kmol/hr) | V/V_{FEED} | H₂ | CH₄ | CO₂ | N₂ |
| Feed | 4680 | 1.00 | 90.90% | 8% | 0.30% | 0.80% |
| Product | 4287.0 | 0.916 | 99% | 0.90% | | 0.10% |
| Purge in | 2.94 | 0.001 | 99% | 0.90% | | 0.10% |
| Purge out | 112.6 | 0.024 | 69.65% | 26.90% | 0.78% | 2.67% |
| Blowdown | 1588.0 | 0.34 | 69.65% | 26.90% | 0.78% | 2.67% |
| Pressurization | 1326.0 | 0.28 | 90.90% | 8% | 0.30% | 0.80% |
| (from feed) | | | | | | |

The values obtained for Case 1 were: Hydrogen recovery: 77.8%. Hydrogen purity: 99%. For purge out stream used for fuel, N₂ rejection 15.18% and CH₄ recovery 85.7%. For purge out stream recycled back to reactor, N₂ rejection 8.9% and CH₄ recovery 91.2%. The productivity was 6.19 kmol/hr/m³ bed. Based on the configuration shown in FIG. 3, where one process train has 12 beds, 2.6 trains would be needed to process a 49 ton/hr stream with composition of 90.9% H₂, 8% CH₄, 0.3% CO₂, and 0.8% N₂. Hydrogen recovery is defined as moles of H₂ in the hydrogen-containing product divided by moles of H₂ in the feed plus pressurization.

It is noted that CH₄ recovery and N₂ rejection in Cases 1, 3, and 5 varies based on whether the purge out stream is used for recycle or for fuel in another process. When the purge out stream is used for recycle, the CH₄ recovery is defined the total moles of CH₄ that are recycled (blowdown plus purge out) divided by the total moles of CH₄ that enter the reactor (feed and the pressurization). When purge out is used for recycle, N₂ rejection is total moles of N₂ that exit via the hydrogen-containing product divided by total moles of N₂ that enter the reactor (feed and the pressurization). By contrast, when the purge out stream is used for fuel, the CH₄ recovery is defined the total moles of CH₄ that are recycled (blowdown only) divided by the total moles of CH₄ that enter the reactor (feed and the pressurization). When purge out is used for fuel, N₂ rejection is total moles of N₂ that exit via the hydrogen-containing product and via the purge divided by total moles of N₂ that enter the reactor (feed and the pressurization).

Case 3—PSA, Activated carbon. Blowdown and purge pressure are atmospheric. Activated carbon layer length was 6.0 m. Table 7 lists the calculated stream flowrates and compositions for Case 3. The column V/V_{FEED} refers to the ratio of stream molar flow rate to that of feed stream.

TABLE 7
Compositions and Flow Rates for Case 3

| | flowrate | | | | | |
|---|---|---|---|---|---|---|
| | (kmol/hr) | V/Vfeed | H₂ | CH4 | CO2 | N2 |
| Feed | 3588 | 1.00 | 90.90% | 8% | 0.30% | 0.80% |
| Product | 3006.4 | 0.84 | 99.00% | 0.86% | 0.00% | 0.14% |
| Purge in | 2.95 | 0.00 | 99.00% | 0.86% | 0.00% | 0.14% |
| Purge out | 86.51 | 0.02 | 55.87% | 39.76% | 1.40% | 2.98% |
| Blowdown | 1496.80 | 0.42 | 76.59% | 20.57% | 0.84% | 2.00% |
| Pressurization | 1014.0 | 0.28 | 90.90% | 8% | 0.30% | 0.80% |

The values obtained for Case 3 were: Hydrogen recovery: 71.1%. Hydrogen purity: 99%. For purge out stream used for fuel, N₂ rejection 18.7% and CH₄ recovery 83.6%. For purge out stream recycle back to reactor, N₂ rejection 11.7% and CH₄ recovery 93.022%. The productivity was 4.34 kmol/hr/m³ bed. Based on the configuration shown in FIG. 3, where one process train has 12 beds, 3.4 trains would be needed to process 49 ton/hr stream with composition of 90.9% H₂, 8% CH₄, 0.3% CO₂, and 0.8% N₂.

Case 5—PSA, MFI zeolite. Blowdown and purge pressure are atmospheric. Activated carbon layer length was 6.0 m. Table 8 lists the calculated stream flowrates and compositions for case 5. The column V/V_{FEED} refers to the ratio of stream molar flow rate to that of feed stream.

TABLE 8
Compositions and Flow Rates for Case 5

| | flowrate | | | | | |
|---|---|---|---|---|---|---|
| | (kmol/hr) | V/Vfeed | H₂ | CH4 | CO2 | N2 |
| Feed | 3744 | 1.00 | 90.90% | 8% | 0.30% | 0.80% |
| Product | 3184.4 | 0.85 | 99.05% | 0.84% | 0.00% | 0.11% |
| Purge in | 2.94 | 0.00 | 99.05% | 0.84% | 0.00% | 0.11% |
| Purge out | 88.45 | 0.02 | 52.07% | 43.28% | 1.50% | 3.15% |
| Blowdown | 1472.19 | 0.39 | 75.54% | 21.43% | 0.88% | 2.15% |
| Pressurization | 1014.0 | 0.27 | 90.90% | 8% | 0.30% | 0.80% |

The values obtained for Case 5 were: Hydrogen recovery: 71.1%. Hydrogen purity: 99%. For purge out stream used for fuel, N₂ rejection 16.8% and CH₄ recovery 82.9%. For purge out stream recycle back to reactor, N₂ rejection 9.5% and CH₄ recovery 93.01%. The productivity was 4.6 kmol/hr/m³ bed. Based on the configuration shown in FIG. 3, where one process train has 12 beds, 3.3 trains would be needed to process 49 ton/hr stream with composition of 90.9% H₂, 8% CH₄, 0.3% CO₂, and 0.8% N₂.

Case 2—PSA with internal recycle, Stacked bed of activated carbon and zeolite 13X. Blowdown and purge pressure are atmospheric. Activated carbon layer length is 0.5 m and the zeolite layer length is 5.5 m. Table 9 lists the calculated stream flowrates and compositions for case 2. The column V/V_{FEED} refers to the ratio of stream molar flow rate to that of feed stream. It is noted that in Case 2, instead of using feed to re-pressurize, a portion of the blowdown is compressed to 1000 kPa-a and used to re-pressurize. This increases hydrogen recovery.

TABLE 9
Compositions and Flow Rates for Case 2

| | flowrate | | | | | |
|---|---|---|---|---|---|---|
| | (kmol/hr) | V/Vfeed | H₂ | CH4 | CO2 | N2 |
| Feed | 4134 | 1.000 | 90.90% | 8% | 0.30% | 0.80% |
| Product | 3326.9 | 0.805 | 99.04% | 0.84% | | 0.118% |
| Purge in | 8.63 | 0.002 | 99.04% | 0.84% | | 0.12% |
| Purge out | 191.57 | 0.046 | 39.07% | 53.70% | 1.90% | 5.33% |
| Blowdown | 1714.3 | 0.415 | 63.30% | 33.32% | 1.23% | 3.15% |

The values obtained for Case 2 were: Hydrogen recovery: 87.8%. Hydrogen purity: 99%. For purge out stream used for fuel, N₂ rejection 42.7% and CH₄ recovery 60.4%. For purge out stream recycle back to reactor, N₂ rejection 11.2% and CH₄ recovery 91.6%. The productivity was 4.8 kmol/hr/m³ bed. Based on the configuration shown in FIG. 3, where one process train has 12 beds, 3.4 trains would be needed to process 49 ton/hr stream with composition of 90.9% H₂, 8% CH₄, 0.3% CO₂, and 0.8% N₂. Because the blowdown is used for re-pressurization, hydrogen recovery is moles of H₂ in the product divided by moles of H₂ in the feed.

It is noted that CH₄ recovery and N₂ rejection in Case 2 varies based on whether the purge out stream is used for recycle or for fuel in another process. When the purge out stream is used for recycle, the CH₄ recovery is defined the total moles of CH₄ that are recycled (blowdown plus purge out) divided by the total moles of CH₄ in the feed. When purge out is used for recycle, N₂ rejection is total moles of N₂ that exit via the hydrogen-containing product divided by total moles of N₂ in the feed. By contrast, when the purge out stream is used for fuel, the CH₄ recovery is defined the total moles of CH₄ that are recycled (blowdown only) divided by the total moles of CH₄ in the feed. When purge out is used for fuel, N₂ rejection is total moles of N₂ that exit via the hydrogen-containing product and via the purge divided by total moles of N₂ in the feed.

Case 4—VPSA with internal recycle, Activated carbon. After blowdown to atmospheric pressure, bed is evacuated to further remove adsorbed components. In Case 4, an evacuation pressure of 20 kPa-a was used. Activated carbon layer length is 6.0 m. Table 10 lists the calculated stream flowrates and compositions for case 2. The column V/V_{FEED} refers to the ratio of stream molar flow rate to that of feed stream. It is noted that in Case 2, instead of using feed to re-pressurize, a portion of the blowdown is compressed to 1000 kPa-a and used to re-pressurize. This increases hydrogen recovery.

TABLE 10
Compositions and Flow Rates for Case 4

| | flowrate | | | | | |
|---|---|---|---|---|---|---|
| | (kmol/hr) | V/Vfeed | H₂ | CH4 | CO2 | N2 |
| Feed | 6786 | 1.00 | 90.9% | 8.0% | 0.30% | 0.80% |
| Product | 5247.6 | 0.77 | 99.0% | 0.8% | 0.00% | 0.19% |
| Evacuation | 622.39 | 0.09 | 59.5% | 36.4% | 1.34% | 2.80% |
| out | | | | | | |
| Blowdown | 1914.78 | 0.28 | 78.8% | 18.5% | 0.78% | 1.84% |
| Pressurization | 1014.0 | 0.15 | 90.9% | 8.0% | 0.3% | 0.8% |
| (from feed) | | | | | | |

The values obtained for Case 2 were: Hydrogen recovery: 73.3%. Hydrogen purity: 99%. For evacuation out stream used for fuel, N₂ rejection 43.6% and CH₄ recovery 56.9%. For evacuation out stream recycle back to reactor, N₂ rejection 15.6% and CH₄ recovery 93.2%. The productivity was 7.58 kmol/hr/m³ bed. Based on the configuration shown in FIG. 1, where one process train has 12 beds, 1.9 trains would be needed to process 49 ton/hr stream with composition of 90.9% H₂, 8% CH₄, 0.3% CO₂, and 0.8% N₂.

It is noted that CH₄ recovery and N₂ rejection in Case 5 varies based on whether the evacuation out stream is used for recycle or for fuel in another process. When the evacuation out stream is used for recycle, the CH₄ recovery is defined the total moles of CH₄ that are recycled (blowdown plus evac out) divided by the total moles of CH₄ in the feed. When purge out is used for recycle, N₂ rejection is total moles of N₂ that exit via the hydrogen-containing product divided by total moles of N₂ in the feed. By contrast, when the evacuation out stream is used for fuel, the CH₄ recovery is defined the total moles of CH₄ that are recycled (blowdown only) divided by the total moles of CH₄ in the feed. When evacuation out is used for fuel, N₂ rejection is total moles of N₂ that exit via the hydrogen-containing product and during evacuation divided by total moles of N₂ in the feed.

### Example 3—Comparison of Packed Bed and Structured Bed Processes

Table 11 compares the performance of PVSA and PSA cycles with the structured and packed beds. It is seen that with the packed bed configurations the H₂ recovery is ˜73%, while for the structured bed the recovery increases to ˜89%. This is the result of a lower voidage in the monolithic adsorbent as opposed to the packed bed. Also the productivity of the structured adsorbent is higher due to higher flow rates.

TABLE 11
Comparison of Packed Bed and Structured Bed Processes

| | | | H₂ | CH4 | N2 | Productivity |
|---|---|---|---|---|---|---|
| Case | Cycle | Material | rec. | rec. | rejection | (kmol/hr/m³) |
| 6 | PVSA | Structured | 89% | 92.6% | 33% | 28 |
| | (0.2 | adsorbent | | | | |
| | bar) | MFI | | | | |
| 7 | PVSA | Packed | 73% | 57% | 44% | 7.6 |
| | (0.2 | bed | | | | |
| | bar) | AC | | | | |
| 8 | PSA | Packed | 73% | 83% | 17% | 4.6 |
| | | bed | | | | |
| | | MFI | | | | |

### Additional Embodiments

Embodiment 1. A method for separating hydrogen from methane pyrolysis products using a plurality of adsorbent beds, comprising: performing pyrolysis on a feed comprising C₁-C₄ hydrocarbons to form a pyrolysis effluent comprising, on a dry basis, 60 vol % or more of H₂ and 1.0 vol % or more CH₄; separating at least a portion of the pyrolysis effluent to form a hydrogen-containing effluent, a recycle stream, and a purge stream, the hydrogen-containing stream comprising 85.0 vol % or more H₂, wherein the hydrogen-containing stream contains 50 vol % or more of the H₂ contained in the feed, and wherein the recycle stream contains 80 vol % or more of the CH₄ contained in the feed.

Embodiment 2. A method for separating hydrogen from methane pyrolysis products using a plurality of adsorbent beds, comprising: performing pyrolysis on a feed comprising C₁-C₄ hydrocarbons to form a pyrolysis effluent comprising, on a dry basis, 60 vol % or more of H₂ and 1.0 vol % or more CH₄; separating at least a portion of the pyrolysis effluent using a separation process comprising exposing the at least a portion of the pyrolysis effluent to a structured adsorbent contactor to form a hydrogen-containing effluent, a recycle stream, and a purge stream, the hydrogen-containing stream comprising 85 vol % or more H₂, wherein the hydrogen-containing stream contains 50 vol % or more of the H₂ contained in the feed, and wherein the recycle stream contains 80 vol % or more of the CH₄ contained in the feed.

Embodiment 3. The method of Embodiment 1 or 2, wherein the feed further comprises N₂, wherein the pyrolysis effluent comprises 7.0 vol % or less of N₂ (or 5.0 vol % or less, or 3.0 vol % or less), and wherein the hydrogen-containing stream comprises 1.0 vol % or more N₂.

Embodiment 4. The method of Embodiment 3, a) wherein the hydrogen-containing stream comprises 10 vol % or more of the N₂ contained in the feed, or b) wherein the recycle stream comprises less than 85 vol % of the N₂ contained in the feed, or c) wherein the purge stream contains 6.0 vol % or more of the N₂ contained in the feed, or d) a combination of two or more of a), b), and c).

Embodiment 5. The method of any of the above embodiments, wherein the feed further comprises 5.0 vol % or less of carbon oxides, and wherein the recycle stream contains less than 85 vol % of the carbon oxides contained in the feed.

Embodiment 6. The method of any of the above embodiments, wherein the pyrolysis effluent comprises 80 vol % or more of H₂.

Embodiment 7. The method of any of the above embodiments, wherein the hydrogen-containing stream comprises 70 vol % or more (or 80 vol % or more) of the H₂ contained in the pyrolysis effluent.

Embodiment 8. The method of any of the above embodiments, wherein the separating at least a portion of the pyrolysis effluent comprises using a separation process that comprises a pressure of 50 kPa-a or less to form the hydrogen-containing effluent, the recycle stream, and the purge stream.

Embodiment 9. The method of any of the above embodiments, wherein the sorbent comprises activated charcoal, a silica gel, a zeolite, or a combination thereof.

Embodiment 10. The method of any of the above embodiments, wherein the sorbent comprises a siliceous zeolite.

Embodiment 11. The method of Embodiment 10, wherein the sorbent comprises a siliceous zeolite having an MFI framework structure, an FER framework structure, or a combination thereof.

Embodiment 12. The method of any of Embodiments 2-11, wherein the structured adsorbent contactor comprises a parallel channel contactor, or wherein the structured adsorbent contactor comprises a monolith.

Embodiment 13. The method of any of Embodiments 2-12, wherein the structured adsorbent channel contactor comprises a void fraction of 36% or less.

Embodiment 14. The method of any of the above embodiments, wherein the separating comprises: passing at least a portion of the pyrolysis effluent into a first sorption environment containing a first sorbent bed comprising a sorbent with selectivity for sorption of N₂ and CO₂ relative to H₂ at a first sorption pressure of 500 kPa-a to 1500 kPa-a to form a hydrogen-containing product effluent having an H₂ content of 98.0 vol % or more and a loaded first sorbent comprising adsorbed CO₂, the first sorption environment containing an additional volume of the hydrogen-containing product at the end of the passing; flowing a first portion of the additional volume of the hydrogen-containing product into a second sorption environment containing a second sorbent bed comprising the sorbent to reduce the pressure in the first sorption environment to a first reduced pressure and increase the pressure in the second sorption environment; flowing a second portion of the additional volume of the hydrogen-containing product into a third sorption environment containing a third sorbent bed comprising the sorbent to reduce the pressure in the first sorption environment to a second reduced pressure and increase the pressure in the third sorption environment; exhausting a blowdown portion of the additional volume of the hydrogen-containing product to reduce the pressure in the first sorption environment to 120 kPa-a or less; desorbing at least a portion of the adsorbed CO₂ to form a CO₂-containing stream, the feed comprising C₁-C₄ hydrocarbons further comprising a first portion of the CO₂-containing stream; purging a second portion of the CO₂-containing stream; passing a first pressurization stream comprising an H₂ content of 98.0 vol % or more into the first sorption environment from a fourth sorption environment to increase the pressure in the first sorption environment to a pressure greater than 200 kPa-a; passing a second pressurization stream comprising an H₂ content of 98.0 vol % or more into the first sorption environment from a fifth sorption environment to increase the pressure in the first sorption environment to a pressure between the first reduced pressure and the second reduced pressure; and passing a re-pressurization stream comprising 98 vol % or more H₂ into the first sorption environment to increase the pressure in the first sorption environment to a second sorption pressure, a ratio of the second sorption pressure to the first sorption pressure being between 0.9 and 1.1.

Embodiment 15. The method of Embodiment 14, wherein the re-pressurization stream comprises a portion of the hydrogen-containing product effluent; or wherein the method further comprises compressing a recycle portion of the blowdown portion, the re-pressurization stream comprising the recycle portion of the blowdown portion; or a combination thereof.

Embodiment 16. The method of Embodiment 14 or 15, wherein desorbing at least a portion of the adsorbed CO₂ comprises reducing the pressure in the first sorption environment to 50 kPa-a or less, the desorbing at least a portion of the adsorbed CO₂ optionally comprising maintaining the pressure of the first sorption environment at a pressure of 50 kPa-a or less for an exhaust time that is greater than a time for performing the passing of the at least a portion of the pyrolysis effluent.

Embodiment 17. The method of any of Embodiments 14 to 16, wherein desorbing at least a portion of the adsorbed CO₂ comprises purging the first sorption environment with a purge flow comprising a portion of the hydrogen-containing product stream, a portion of the blowdown portion of the additional volume of hydrogen-containing product, or a combination thereof.

Embodiment 18. The method of any of Embodiments 14 to 17, wherein a ratio of the first reduced pressure to the first sorption pressure is 0.60 to 0.80, or wherein a ratio of the second reduced pressure to the first reduced pressure is 0.50 to 0.80, or a combination thereof.

Embodiment 19. The method of any of the above embodiments, wherein the method further comprises compressing the pyrolysis effluent to a pressure between 600 kPa-a and 1500 kPa-a.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A method for separating hydrogen from methane pyrolysis products using a plurality of adsorbent beds, comprising:
performing pyrolysis on a feed comprising C₁-C₄ hydrocarbons to form a pyrolysis effluent comprising, on a dry basis, 60 vol % or more of H₂ and 1.0 vol % or more CH₄;
separating at least a portion of the pyrolysis effluent to form a hydrogen-containing effluent, a recycle stream, and a purge stream, the hydrogen-containing stream comprising 85.0 vol % or more H₂,
wherein the hydrogen-containing stream contains 50 vol % or more of the H₂ contained in the feed, and
wherein the recycle stream contains 80 vol % or more of the CH₄ contained in the feed.

2. The method of claim 1, wherein the feed further comprises N₂, wherein the pyrolysis effluent comprises 7.0 vol % or less of N₂, and wherein the hydrogen-containing stream comprises 1.0 vol % or more N₂.

3. The method of claim 2, a) wherein the hydrogen-containing stream comprises 10 vol % or more of the N₂ contained in the feed, or b) wherein the recycle stream comprises less than 85 vol % of the N₂ contained in the feed, or c) wherein the purge stream contains 6.0 vol % or more of the N₂ contained in the feed, or d) a combination of two or more of a), b), and c).

4. The method of claim 1, wherein the feed further comprises 5.0 vol % or less of carbon oxides, and wherein the recycle stream contains less than 85 vol % of the carbon oxides contained in the feed.

5. The method of claim 1, wherein the pyrolysis effluent comprises 80 vol % or more of H₂; or wherein the hydrogen-containing stream comprises 70 vol % or more of the H₂ contained in the pyrolysis effluent; or a combination thereof.

6. The method of claim 1, wherein the separating at least a portion of the pyrolysis effluent comprises using a separation process that comprises a pressure of 50 kPa-a or less to form the hydrogen-containing effluent, the recycle stream, and the purge stream.

7. The method of claim 6, wherein the feed further comprises N₂, wherein the pyrolysis effluent comprises 5.0 vol % or less of N₂, and wherein the hydrogen-containing stream comprises 1.0 vol % or more N₂.

8. The method of claim 7, i) wherein the hydrogen-containing stream comprises 15 vol % or more of the N₂ contained in the feed, or ii) wherein the recycle stream comprises less than 60 vol % of the N₂ contained in the feed, or iii) wherein the purge stream contains 25 vol % or more of the N₂ contained in the feed, or iv) a combination of two or more of i), ii), and iii).

9. The method of claim 1, wherein the sorbent comprises activated charcoal, a silica gel, a zeolite, a siliceous zeolite, or a combination thereof.

10. The method of claim 1, wherein the sorbent comprises a siliceous zeolite having an MFI framework structure, an FER framework structure, or a combination thereof.

11. The method of claim 1, wherein the sorbent comprises activated charcoal and a zeolite, the activated charcoal being located upstream from the zeolite relative to a direction of flow for the at least a portion of the pyrolysis effluent during the passing the at least a portion of the pyrolysis effluent.

12. The method of claim 1, wherein the separating comprises:
passing at least a portion of the pyrolysis effluent into a first sorption environment containing a first sorbent bed comprising a sorbent with selectivity for sorption of N₂ and CO₂ relative to H₂ at a first sorption pressure of 500 kPa-a to 1500 kPa-a to form a hydrogen-containing product effluent having an H₂ content of 98.0 vol % or more and a loaded first sorbent comprising adsorbed CO₂, the first sorption environment containing an additional volume of the hydrogen-containing product at the end of the passing;
flowing a first portion of the additional volume of the hydrogen-containing product into a second sorption environment containing a second sorbent bed comprising the sorbent to reduce the pressure in the first sorption environment to a first reduced pressure and increase the pressure in the second sorption environment;
flowing a second portion of the additional volume of the hydrogen-containing product into a third sorption environment containing a third sorbent bed comprising the sorbent to reduce the pressure in the first sorption environment to a second reduced pressure and increase the pressure in the third sorption environment;
exhausting a blowdown portion of the additional volume of the hydrogen-containing product to reduce the pressure in the first sorption environment to 120 kPa-a or less;
desorbing at least a portion of the adsorbed CO₂ to form a CO₂-containing stream, the feed comprising C₁-C₄ hydrocarbons further comprising a first portion of the CO₂-containing stream;
purging a second portion of the CO₂-containing stream;
passing a first pressurization stream comprising an H₂ content of 98.0 vol % or more into the first sorption environment from a fourth sorption environment to increase the pressure in the first sorption environment to a pressure greater than 200 kPa-a;
passing a second pressurization stream comprising an H₂ content of 98.0 vol % or more into the first sorption environment from a fifth sorption environment to increase the pressure in the first sorption environment to a pressure between the first reduced pressure and the second reduced pressure; and
passing a re-pressurization stream comprising 98 vol % or more H₂ into the first sorption environment to increase the pressure in the first sorption environment to a second sorption pressure, a ratio of the second sorption pressure to the first sorption pressure being between 0.9 and 1.1.

13. The method of claim 12, wherein the re-pressurization stream comprises a portion of the hydrogen-containing product effluent.

14. The method of claim 12,
A) wherein desorbing at least a portion of the adsorbed CO₂ comprises reducing the pressure in the first sorption environment to 50 kPa-a or less;
B) wherein desorbing at least a portion of the adsorbed CO₂ comprises maintaining the pressure of the first sorption environment at a pressure of 50 kPa-a or less for an exhaust time that is greater than a time for performing the passing of the at least a portion of the pyrolysis effluent; or
C) wherein desorbing at least a portion of the adsorbed CO₂ comprises purging the first sorption environment with a purge flow comprising a portion of the hydrogen-containing product stream, a portion of the blowdown portion of the additional volume of hydrogen-containing product, or a combination thereof.

15. The method of claim 12, wherein the method further comprises compressing a recycle portion of the blowdown portion, the re-pressurization stream comprises the recycle portion of the blowdown portion; or wherein the method further comprises compressing the pyrolysis effluent to a pressure between 600 kPa-a and 1500 kPa-a; or a combination thereof.

16. The method of claim 12, wherein a ratio of the first reduced pressure to the first sorption pressure is 0.60 to 0.80, or wherein a ratio of the second reduced pressure to the first reduced pressure is 0.50 to 0.80, or a combination thereof.

17. A method for separating hydrogen from methane pyrolysis products using a plurality of adsorbent beds, comprising:
performing pyrolysis on a feed comprising C₁-C₄ hydrocarbons to form a pyrolysis effluent comprising, on a dry basis, 60 vol % or more of H₂ and 1.0 vol % or more CH₄;
separating at least a portion of the pyrolysis effluent using a separation process comprising exposing the at least a portion of the pyrolysis effluent to a structured adsorbent contactor to form a hydrogen-containing effluent, a recycle stream, and a purge stream, the hydrogen-containing stream comprising 85 vol % or more H₂,
wherein the hydrogen-containing stream contains 50 vol % or more of the H₂ contained in the feed, and
wherein the recycle stream contains 80 vol % or more of the CH₄ contained in the feed.

18. The method of claim 17, I) wherein the structured adsorbent contactor comprises a parallel channel contactor; II) wherein the structured adsorbent contactor comprises a monolith; III) wherein the structured adsorbent channel contactor comprises a void fraction of 36% or less; or IV) a combination of two or more of I), II), and III).

19. The method of claim 17, wherein the feed further comprises N₂, wherein the pyrolysis effluent comprises 7.0 vol % or less of N₂, and wherein the hydrogen-containing stream comprises 1.0 vol % or more N₂.

20. The method of claim 17, a) wherein the hydrogen-containing stream comprises 10 vol % or more of the N₂ contained in the feed, or b) wherein the recycle stream comprises less than 85 vol % of the N₂ contained in the feed, or c) wherein the purge stream contains 6.0 vol % or more of the N₂ contained in the feed, or d) a combination of two or more of a), b), and c).

21. The method of claim 17, wherein the feed further comprises 5.0 vol % or less of carbon oxides, and wherein the recycle stream contains less than 85 vol % of the carbon oxides contained in the feed.

22. The method of claim 17, wherein the pyrolysis effluent comprises 80 vol % or more of H₂; or wherein the hydrogen-containing stream comprises 70 vol % or more of the H₂ contained in the pyrolysis effluent; or a combination thereof.

23. The method of claim 17, wherein the separating at least a portion of the pyrolysis effluent comprises using a separation process that comprises a pressure of 50 kPa-a or less to form the hydrogen-containing effluent, the recycle stream, and the purge stream.

24. The method of claim 17, wherein the feed further comprises N₂, wherein the pyrolysis effluent comprises 5.0 vol % or less of N₂, the hydrogen-containing stream comprising 1.0 vol % or more N₂; or wherein the feed further comprises 5.0 vol % or less of carbon oxides, the recycle stream containing less than 85 vol % of the carbon oxides contained in the feed; or a combination thereof.

25. The method of claim 17, wherein the sorbent comprises activated charcoal, a silica gel, a zeolite, a siliceous zeolite, or a combination thereof.
